(19) United States
(12) Patent Application Publication
(10) Pub. No.: US 2026/0119968 A1
(43) Pub. Date: Apr. 30, 2026

(54) EXPECTED SELECTED IMPRESSIONS USING FREQUENCY CONSTRAINTS

(71) Applicant: Walmart Apollo, LLC, Bentonville, AR (US)

(72) Inventors: Girish Sathyanarayana, Mysore (IN); Konstantin Shmakov, San Jose, CA (US); Danish Shaikh, Bangalore (IN); Kunal Kishore, Bengaluru (IN); Sanjoy Bose, Bangalore (IN); Pratyush Pushkar, Bangalore (IN)

(21) Appl. No.: 18/926,691

(22) Filed: Oct. 25, 2024

(51) Int. Cl. G06N 20/00; H04L 67/50; H04N 21/25

(52) U.S. Cl. CPC G06N 20/00; H04L 67/535; H04N 21/251

(57) ABSTRACT

Example implementations relate to expected selected impression determinations using frequency cap parameters. In an example, a likelihood request for display of digital content is received. The likelihood request includes at least one constraint parameter and at least one frequency cap parameter. A first quantity of impressions per user is obtained based on the at least one constraint parameter and a suppression ratio for the at least one frequency cap parameter is determined. The suppression ratio is a ratio of a selection likelihood under the at least one constraint parameter and the frequency cap parameter to a selection likelihood under the at least one constraint parameter. One or more of the first quantity of impressions per user is suppressed based on the suppression ratio to generate a second quantity of impressions per user and the at least one constraint parameter is adjusted based on the second quantity of impressions per user.

### TECHNICAL FIELD

This application relates generally to digital space allocation, and more particularly, to determining an expected selected quantity of digital space using frequency constraint parameters.

### BACKGROUND

Digital space, such as portions of a webpage, network interface, digital display, or other digital space, may be utilized for display of interface elements on behalf of one or more parties. Digital space may be provided in guaranteed digital space (e.g., an entity is ensured of a specific portion of digital space for a specific time and a specific duration) or non-guaranteed digital space (e.g., multiple entities may request a portion of a digital space for a specific time and specific duration that are overlapping). Non-guaranteed digital space may be allocated based on one or more parameters provided by each entity attempting to obtain the non-guaranteed digital space.

Entities that attempt to obtain non-guaranteed digital space must determine how to allocate resources. Some current systems estimate performance of non-guaranteed digital space based on provided parameters. However, these systems perform general estimation and do not take into account diminishing returns caused by space usage constraints for inclusion of digital content within a digital space that is provided to or observed by repeated individual users of the space.

### BRIEF DESCRIPTION OF THE DRAWINGS

Various examples will be described below with reference to the following figures.

FIG. 1 depicts an example system that determines an expected selected impressions quantity and automatically adjusts one or more digital space campaigns, in accordance with some embodiments.

FIG. 2 depicts an example online content delivery system, in accordance with some embodiments.

FIG. 3 depicts an example of a selected impression determination process, in accordance with some embodiments.

FIG. 4 depicts a flowchart illustrating an example method for determining selected impressions with frequency capping constraints, in accordance with some embodiments.

FIGS. 5A-5B depict a flowchart illustrating an example method for determining selected impression rates without frequency capping constraints and with frequency capping constraints, in accordance with some embodiments.

FIG. 6 depicts an example system with a machine-readable medium that includes instructions for determining a total quantity of expected selected impressions, in accordance with some embodiments.

FIG. 7 depicts an example computer system that implements one or more of the disclosed processes, in accordance with some embodiments.

### DETAILED DESCRIPTION

The disclosed systems and methods provide targeted determinations for usage of digital space based in part on frequency parameters defining diminishing returns caused by space usage constraints for inclusion of digital content within a digital space. As discussed in greater detail below, in some embodiments, the generation of frequency cap aware impressions per user through determination of a suppression factor and suppression of certain impressions in frequency cap agnostic impressions per user provide improvements over prior systems that allow determinations to be made with high accuracy including impacts of frequency restrictions that limit the quantity of impressions that may occur for a unique user of a digital space. The generation of frequency cap aware impressions per user through the use of a suppression factor provides an improvement over prior processes by both improving operation of the underlying system (e.g., by reducing the computational cost for determining expected impressions due to the suppression of impressions per user from the frequency agnostic impression-per-user) and an improvement to digital space usage determinations (e.g., by providing higher accuracy determinations that account for relevant frequency cap parameters that impact the quantity or frequency of impressions for each unique user). Additionally, in some embodiments, a most restrictive frequency cap parameter is identified. Use of a most restrictive frequency cap parameter from a set of frequency cap parameters provides an improvement over prior systems as discussed above with respect to higher accuracy determinations and lower computational costs. The use of a most restrictive frequency cap parameter provides an additional improvement to the system (e.g., by further reducing the computational costs in processing only a single, most restrictive frequency cap parameter) and an improvement to digital space usage determinations (e.g., by providing a highest accuracy determination based on the most restrictive frequency cap parameter and preventing over suppression due to impacts of multiple overlapping frequency cap parameters). These and other advantages will be apparent from the disclosure herein.

This description of the example embodiments is intended to be read in connection with the accompanying drawings that are to be considered part of the entire written description. Terms concerning data connections, coupling and the like, such as “connected” and “interconnected,” and/or “in signal communication with” refer to a relationship wherein systems or elements are electrically connected (e.g., wired or wireless) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

In various embodiments, a system including a processor and a non-transitory memory storing instructions is disclosed. The instructions, when executed, cause the processor to receive a likelihood request for display of digital content in a non-guaranteed digital space. The likelihood request includes at least one constraint parameter and at least one frequency cap parameter. The instructions further cause the processor to obtain a first quantity of impressions per user based on the at least one constraint parameter and determine a suppression ratio for the at least one frequency cap parameter. The suppression ratio is a ratio of a selection likelihood under the at least one constraint parameter and the frequency cap parameter to a selection likelihood under the at least one constraint parameter. The instructions further cause the processor to suppress one or more of the first quantity of impressions per user based on the suppression ratio to generate a second quantity of impressions per user and adjust the at least one constraint parameter based on the second quantity of impressions per user.

In some embodiments, a computer-implemented method is disclosed. The computer-implemented method includes steps of receiving a likelihood request for display of digital content. The likelihood request includes at least one constraint parameter and at least one frequency cap parameter. The computer-implemented method further includes steps of obtaining a first quantity of impressions per user based on the at least one constraint parameter and determining a suppression ratio for the at least one frequency cap parameter. The suppression ratio is a ratio of a selection likelihood under the at least one constraint parameter and the frequency cap parameter to a selection likelihood under the at least one constraint parameter. The computer-implemented method further includes steps of suppressing one or more of the first quantity of impressions per user based on the suppression ratio to generate a second quantity of impressions per user and adjusting the at least one constraint parameter based on the second quantity of impressions per user.

In some embodiments, a non-transitory computer-readable medium having instructions stored thereon is disclosed. The instructions, when executed by at least one processor, cause at least one device to perform operations including receiving a likelihood request for display of digital content, wherein the likelihood request includes at least one constraint parameter and at least one frequency cap parameter, obtaining a first quantity of expected selected impressions per user based on the at least one constraint parameter, and determining a suppression ratio for the at least one frequency cap parameter. The suppression ratio is a ratio of a selection likelihood under the at least one constraint parameter and the frequency cap parameter to a selection likelihood under the at least one constraint parameter. The instructions further cause the device to perform operations including suppressing one or more of the first quantity of expected selected impressions per user based on the suppression ratio to generate a second quantity of expected selected impressions per user and adjusting the at least one constraint parameter based on the second quantity of impressions per user.

Furthermore, in the following, various embodiments are described with respect to methods and systems for determining a quantity of expected selected digital space. In various embodiments, systems and methods disclosed herein apply one or more frequency parameters to future digital space determinations to account for frequency usage constraints (e.g., frequency caps) of the corresponding digital space. As one non-limiting example, in some embodiments, the digital space may include online, programmatically generated and displayed digital space, such as digital space within a webpage or other network interface. One or more content providers may provide proposals for usage of the digital space on a non-guaranteed basis. That is, the content providers may provide proposals, or bids, for usage of the digital space that include one or more parameters defining the proposed usage. A controlling entity of the digital space, e.g., a website provider, may select a proposal from a content provider that maximizes one or more target parameters. The target parameters may represent limited or consumable resources of the content providers, and the content providers may attempt to maximize the use of the consumable resources by estimating minimum parameters of a usage proposal that will successfully be accepted by the controlling entity.

In some embodiments, content providers may rely on pre-generated determinations of a quantity of instances for presentation of the digital content that will be selected to maximize consumable resources when generating proposals for the digital space. The quantity of available instances for presentation that are selected by a controlling entity for a given proposal may be referred to herein as selected impressions, where an impression is an instance of interaction between a user and the digital space containing the interface element(s) provided by the content provider. The disclosed systems and methods utilize one or more frequency constraints (e.g., frequency caps) to determine expected selected impressions (i.e., the quantity of selected impressions expected based on corresponding parameters) based on frequency restrictions regarding use of the digital space during a time period associated with a usage proposal. The use of frequency constraints allows content providers to obtain a higher accuracy determination for the expected selection of digital content for a digital space, allowing for effective deployment of usage proposals across one or more non-guaranteed digital spaces.

In some embodiments, the disclosed systems and methods may be utilized to estimate an impact of changing one or more usage parameters for a proposed or ongoing usage of digital space. A proposal for usage of a digital space including usage parameters and a target time period may be referred to as a campaign. A content provider may utilize the disclosed systems and methods to estimate a total quantity of selections (e.g., expected impressions or expected selections) that will occur during a future time period coinciding with the time period of the proposed campaign.

The disclosed systems and methods provide an improvement to digital space (e.g., website, network page) generation by enabling content providers to allocate digital space usage based on expected selected impression rates that are generated in view of frequency cap parameters. The disclosed systems and methods allow for space allocation and future determinations of expected selected impressions over any future duration of a campaign and over a long-term time horizon. The disclosed systems and methods may utilize contextual, keyword, and behavioral targeting criteria to offer a unified solution that provides quick response time and scalability.

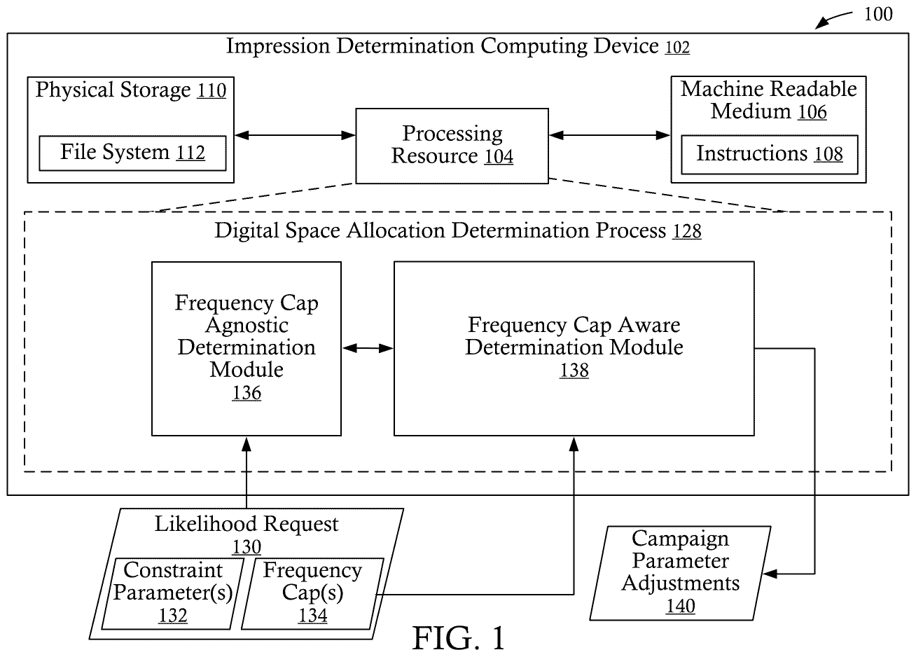

FIG. 1 depicts an example system 100 that determines an expected selected impressions quantity and automatically adjusts one or more digital space campaigns, in accordance with some embodiments. The system 100 includes an impression determination computing device 102 that provides a determination (e.g., an estimation) of a quantity of expected selected impressions for a future time period. The impression determination computing device 102 includes a processing resource 104 that may include one or more microcontrollers, microprocessors, field-programmable gate arrays (FPGAs), application-specific integrated circuits (ASICs), state machines, digital circuitry, and/or any other suitable processing resource. The impression determination computing device 102 includes a non-transitory machine-readable medium 106 that may include one or more of a random access memory (RAM), read-only memory (ROM), electrically erasable programmable read-only memory (EEPROM), flash memory, hard disk, and/or any other suitable memory resource.

The processing resource 104 may execute instructions 108 (i.e., programming or software code) stored on machine-readable medium 106 to perform functions of the impression determination computing device 102, such as instructions to cause the processing resource to implement a digital space allocation determination process 128. The instructions 108 may include instructions for implementing one or more models. In some embodiments, and as will be described further herein, the impression determination computing device 102 may execute one or more models, processes, or algorithms, such as a machine learning model, deep learning model, statistical model, etc., (e.g., implemented as machine-readable instructions) to estimate success of a proposed usage of digital space for a future time period based on parameters associated with the proposed usage.

The impression determination computing device 102 may also include other hardware components, such as physical storage 110. Physical storage 110 may include any physical storage device, such as a hard disk drive, a solid state drive, or the like, or a plurality of such storage devices (e.g., an array of disks), and may be locally attached (e.g., installed) in the impression determination computing device 102. In some implementations, physical storage 110 may be accessed as a block storage device.

In some cases, the impression determination computing device 102 may also include a local file system 112 that may be implemented as a layer on top of the physical storage 110. For example, an operating system may be executing on the impression determination computing device 102 (by virtue of the processing resource 104 executing certain instructions 108 related to the operating system) and the operating system may provide a file system 112 to store data on the physical storage 110.

In some embodiments, a digital space allocation determination process 128 receives a likelihood request 130. The likelihood request 130 includes a request to determine a quantity of expected selected impressions for a given campaign definition for display of digital content within a non-guaranteed digital space during a future time period. The likelihood request 130 includes one or more constraint parameters 132 and one or more frequency cap parameters 134 associated with the likelihood request 130 and/or the digital space. In some embodiments, the constraint parameters 132 may include parameters related to the content to be provided or delivery of content within the digital space during a target time period. The constraint parameters 132 may include, but are not limited to, a targeting cut (Q) parameter, a duration (T) parameter, a resource value (b), or a resource budget (B). The frequency cap parameters 134 may include one or more frequency caps (c) representative of a maximum number of impressions such that impressions from a unique user associated with the digital space does not exceed the frequency cap value during the target period or a subset thereof.

In some embodiments, the likelihood request 130 is generated by a client system that provides a user interface. The user interface allows a user to define one or more constraint parameters 132 and one or more frequency cap parameters 134. The client system may be in communication with an application programming interface (API) service that translates information received from the interface to a likelihood request 130.

In some embodiments, the likelihood request 130 is received by a frequency cap agnostic determination module 136, which receives the one or more constraint parameters 132 and determines a first quantity of impressions per user for the digital content in the digital space during the target period. The first quantity of impressions per user is generated without using or considering the impacts of the one or more frequency cap parameters 134. In some embodiments, the first quantity of impression per user is a ratio quantity representative of a ratio of impressions-to-users based on the provided constraint parameters 132.

In some embodiments, the frequency cap agnostic determination module 136 implements a trained model, such an exponentially saturating overlaps (ESO) model to generate the first quantity of impressions per user. The ESO model may receive historically sampled data for a fixed, short duration and generate the first quantity of impressions per user for the corresponding duration based on constraint parameters 132 and previously generated impression quantities for historically sampled data.

In some embodiments, a frequency cap aware determination module 138 receives the first quantity of impressions per user and generates a second quantity of impressions per user based on one or more frequency cap parameters 134. The frequency cap aware determination module 138 may receive the frequency cap parameters 134 and determine a suppression ratio for at least one frequency cap parameter in the set of frequency cap parameters 134. The suppression ratio may be a ratio of a selection likelihood under the at least one constraint parameter 132 and the frequency cap parameter 134 (e.g., a likelihood that the digital content of a given campaign is selected for inclusion in an instance of the digital space based on the constraint parameters 132 and the frequency cap parameters 134) to a selection likelihood under the at least one constraint parameter, e.g., the suppression ratio is a ratio of frequency capped impressions per user to non-frequency capped impressions per user.

In some embodiments, the suppression ratio is generated for the most restrictive of the frequency cap parameters 134. For example, the frequency cap parameters 134 may include multiple, non-combinable frequency caps, such as a frequency cap of X impressions for a first time period, Y impressions for a second time period, etc. The first and second time periods may be partially overlapping. In some embodiments, the frequency cap aware determination module 138 selects a most restrictive frequency cap parameter, e.g., a frequency cap parameter that results in the lowest value of a suppression ratio, and utilizes the most restrictive frequency cap parameter for generation of the second quantity of impressions per user.

In some embodiments, the digital space allocation determination process 128 utilizes the second quantity of impressions per user to generate one or more campaign parameter adjustments 140 to adjust at least one of the constraint parameters 132 of the original likelihood request 130. For example, in some embodiments, the second quantity of impressions per user may be used to determine a total quantity of expected selected impressions for a campaign, which may be compared to one or more target metrics for the corresponding campaign to determine if the total quantity of expected selected impressions meets the one or more target metrics. One or more campaign parameter adjustments 140 may adjust the second quantity of impressions per user for a future estimation, for example, by reducing the impacts of the determined suppression ratio and/or increasing the first quantity of impressions per user.

In various embodiments, the generation of frequency cap aware impressions per user through determination of a suppression factor and suppression of certain impressions in frequency cap agnostic impressions per user provide improvements over prior systems that allow determinations to be made with high accuracy including impacts of frequency restrictions that limit the quantity of impressions that may occur for a unique user of a digital space. The generation of frequency cap aware impressions per user through the use of a suppression factor provides an improvement over prior processes by both improving operation of the underlying system (e.g., by reducing the computational cost for determining expected impressions due to the suppression of impressions per user from the frequency agnostic impression-per-user) and an improvement to digital space usage determinations (e.g., by providing higher accuracy determinations that account for relevant frequency cap parameters 134 that impact the quantity or frequency of impressions for each unique user).

In some embodiments, use of a most restrictive frequency cap parameter from a set of frequency cap parameters 134 provides an improvement over prior systems as discussed above with respect to higher accuracy determinations and lower computational costs. The use of a most restrictive frequency cap parameter from a set of frequency cap parameters 134 may provide an additional improvement to the system (e.g., by further reducing the computational costs in processing only a single, most restrictive frequency cap parameter) and an improvement to digital space usage determinations (e.g., by providing a highest accuracy determination based on the most restrictive frequency cap parameter and preventing over suppression due to impacts of multiple overlapping frequency cap parameters).

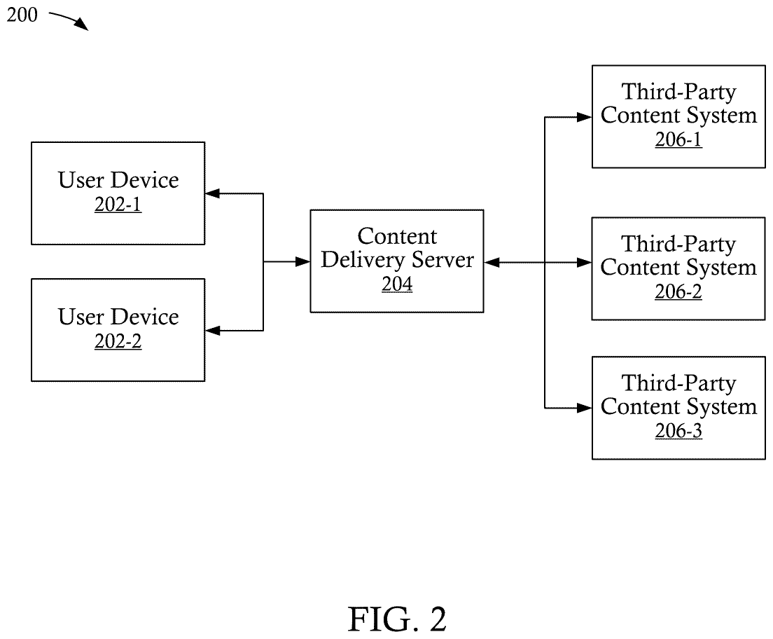

FIG. 2 depicts an example content delivery system 200, in accordance with some embodiments. The content delivery system 200 includes a set of user devices 202-1, 202-2 (collectively user devices 202) that may be operated by one or more users. The user devices 202 may communicate with a content delivery server 204 operated by a first entity. The content delivery server 204 provides one or more digital interfaces that have one or more digital spaces for including digital content. The digital interfaces may include, but are not limited to, webpages, network interfaces, application interfaces, etc. Each digital interface includes at least one digital space that receives digital content for display. A digital space may include a container or other reserved portion of a digital interface that includes one or more positions for displaying digital content, such as digital interface elements. The digital interface may include first party digital spaces (e.g., digital spaces containing elements selected by the operator of the network environment) and third-party digital spaces (e.g., digital spaces that display third party digital content). The digital spaces, such as the third-party digital spaces, may be guaranteed (e.g., the first entity agrees to provide a set of known third-party content in the digital space prior to generation and serving of the digital interface) or non-guaranteed (e.g., the first entity selects one of a plurality of digital space proposals when the digital interface is generated or served to a user device).

In some embodiments, the content delivery server 204 is in communication with one or more third-party content systems 206-1 to 206-3 (collectively the “third-party content systems 206”). Each of the third-party content systems 206 may provide one or more usage proposals for one or more non-guaranteed digital spaces provided by the content delivery server 204 for one or more time periods, e.g., may provide one or more proposed usage campaigns. Each proposed usage campaign may include parameters for usage of the non-guaranteed digital space including an allotment of one or more resources. In some embodiments, a set of proposed usage campaigns may include proposals for the use of the same non-guaranteed digital space during the same duration or in response to the same parameters. The content delivery server 204 may select one of the proposed usage campaigns based on one or more parameters, such as the allotment of the one or more resources for the usage campaign, each time the corresponding digital interface with an instance of the non-guaranteed digital space is generated or served to a user device.

In some embodiments, the content delivery server 204 may implement one or more automated selection processes to select one of the proposed usage campaigns to be utilized each time a request for the corresponding digital interface including the non-guaranteed digital space is received. The automated selection process may include a process that identifies a selected one of the proposed usage campaigns based on a request received from a user device (e.g., a keyword search, an item request, a page request), a remaining quantity of a first resource, and a reduction in the first resource as a result of being selected, whether the proposed usage campaign has met one or more frequency caps, or other relevant factors. As discussed above, third parties may utilize the disclosed systems and methods, such as the digital space allocation determination process 128 discussed above with respect to FIG. 1, to estimate selected impressions per user for a corresponding usage proposal in order to select appropriate parameters to ensure a desired usage of limited resources.

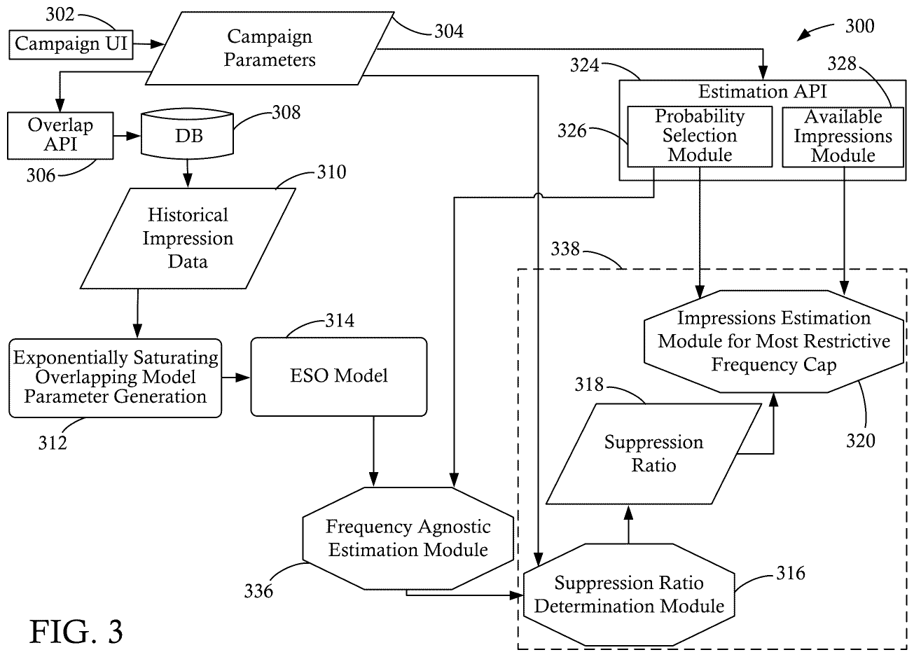

FIG. 3 depicts an example of an impression estimation process 300, in accordance with some embodiments. The impression estimation process 300 may be implemented by any suitable system, such as the system 100 discussed above in conjunction with FIG. 1. In some embodiments, a campaign user interface (UI) 302 receives campaign parameters 304. The campaign UI 302 may be provided by any suitable system, such as a user device in communication with a system implementing the impression estimation process 300. The campaign UI may include interface elements that enable a user to input or select campaign parameters, such as one or more constraint parameters or one or more frequency cap parameters.

The campaign parameters 304 are provided to an overlap API 306 that identifies overlap between the unique users during an initial period (e.g., a first day) and unique users in a subsequent period (e.g., a following day). The overlap API 306 may identify unique users based on a subset of parameters included in the campaign parameters, such as one or more constraint parameters. In some embodiments, a rate of size increase of an overlap user set is determined between users in a first duration and users in a second duration to identify unique users. The overlap API 306 accesses a data store, such as a fast access database (DB) 308, that stores historical impression data for one or more historical campaigns, and samples historical impression data from the set of overlapping campaigns to generate selected impressions per user data.

In some embodiments, the historical impression data 310 is provided to an ESO model parameter generation module 312 that estimates one or more parameters of an ESO model based on the historical impression data 310. The estimated ESO parameters are utilized to implement an ESO model 314 that determines impressions per user for one or more constraint parameters of the campaign parameters 304, such as a targeting cut parameter (Q) and a future campaign duration parameter (T). The ESO model 314 determines a quantity of users that satisfy the at least one constraint based on an overlap factor and historical sampled data for a respective duration.

In some embodiments, the estimated impressions per user for the campaign parameters 304 (e.g., constraint parameters, frequency parameters) and a probability of selection for the campaign parameters 304 are provided to a frequency cap agnostic estimation module 336 that generates a first quantity of impressions per user representing a frequency cap agnostic estimation of impressions per user for the campaign data, for example, as discussed above with respect to FIG. 1. The first quantity of impressions per user and the campaign parameters 304 are provided to a frequency cap aware estimation module 338 including a suppression ratio determination module 316 that generates a suppression ratio 318 for a most restrictive frequency cap included in the campaign parameters 304.

In some embodiments, the suppression ratio 318 is provided to an impressions estimation module that estimates selected impressions for the campaign parameters 304 for the most restrictive frequency cap constraint in the campaign parameters 304, e.g., based on the lowest suppression ratio 318. In some embodiments, the impression estimation module 320 receives a probability of selection for each potential digital space usage from the probability selection module 326 and a total number of available impressions from an available impressions module 328. Each of the probability selection module 326 and the available impressions module 328 may be implemented by an estimation API 324.

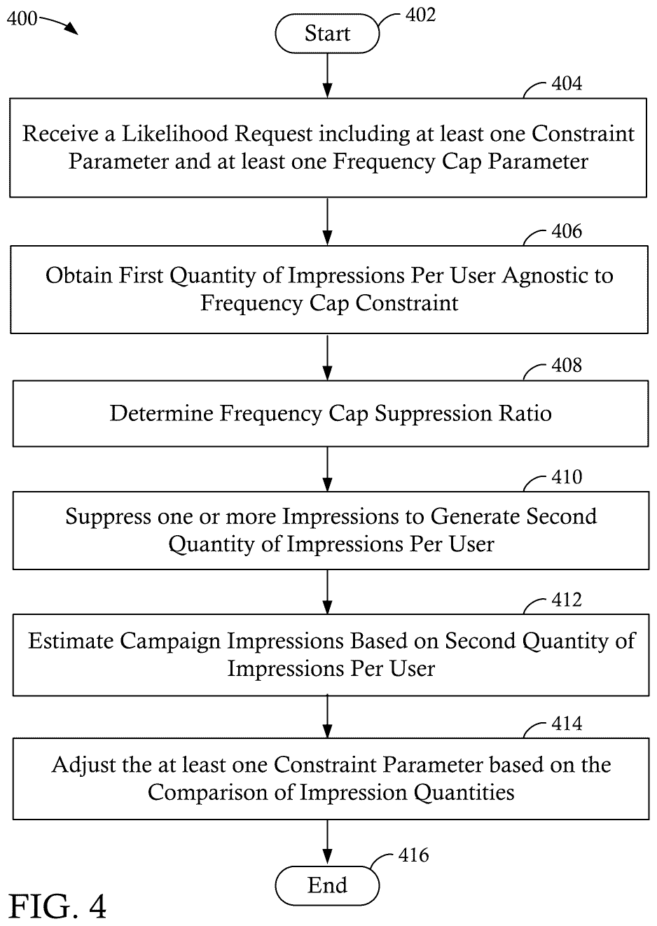

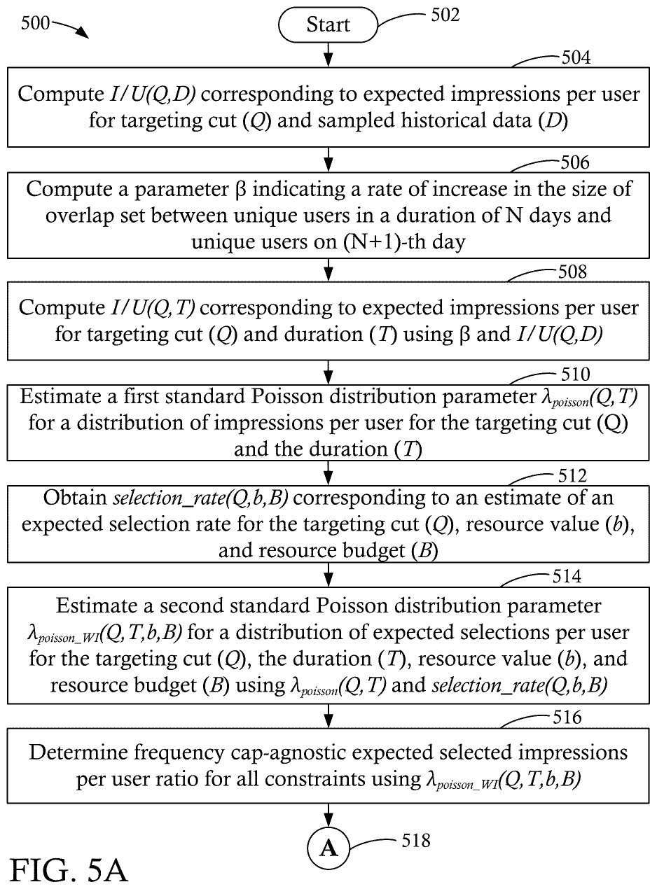

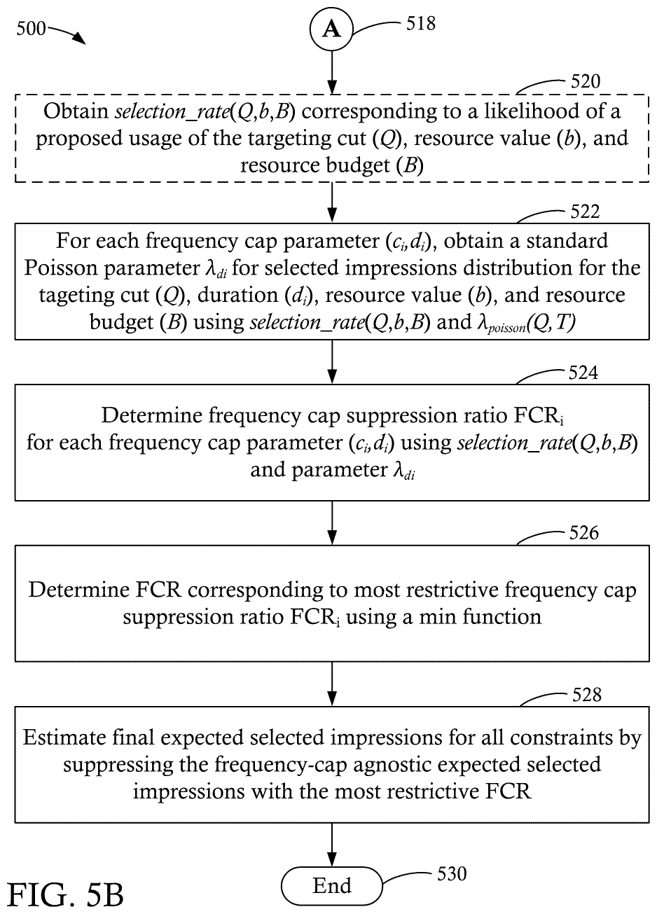

FIGS. 4, 5A, and 5B are flow diagrams depicting example methods. In some embodiments, one or more blocks of the methods may be executed substantially concurrently and/or in a different order than shown. In some implementations, a method may include more or fewer blocks than are shown. In some implementations, one or more of the blocks of a method may, at certain times, be ongoing and/or may repeat. In some implementations, blocks of the methods may be combined.

The methods shown in FIGS. 4, 5A, and 5B may be implemented in the form of executable instructions stored on a machine-readable medium and executed by a processing resource and/or in the form of electronic circuitry. For example, aspects of the methods may be described below as being performed by an estimation process, an example of which may be the digital space allocation determination process 128 running on a hardware processing resource 104 of the impression determination computing device 102 described above. Additionally, other aspects of the method described below may be described with reference to other elements shown in FIG. 1 for non-limiting illustration purposes.

FIG. 4 depicts a flow diagram illustrating a method 400 for estimating selected impressions with frequency capping constraints, in accordance with some embodiments. Method 400 starts at block 402 and continues to block 404, where a likelihood request including at least one constraint parameter and at least one frequency cap parameter is received. The one or more constraint parameters may include parameters for selection of a digital space proposal, such as targeting cuts, duration, allocated resources, etc. The one or more frequency cap parameters may include frequency constraints for a campaign represented by the constraint parameters, such as a first frequency cap parameter of X impressions per unique user for a first time period and a second frequency cap parameter of Y impressions per unique user for a second time period, where the first and second time periods are different.

At block 406, a first quantity of impressions per user agnostic to the frequency cap constraint parameters are obtained. The first quantity of impressions per user may be obtained or determined using any suitable process, such as an ESO process that estimates impressions per user based on past campaigns that have similar (e.g., overlapping) constraint parameters. As discussed above, the first quantity of impressions per user is obtained without consideration of the impact of frequency cap parameters. In this manner, the first quantity of impressions per user is predicted without consideration of the frequency cap parameters.

At block 408, a frequency cap suppression ratio is determined. The frequency cap suppression ratio may be generated for the most restrictive of the frequency cap parameters received at block 404. The suppression ratio is a ratio of a likelihood that the digital content is selected for display under the at least one constraint parameter and the frequency cap constraint to a likelihood the digital content is selected for display under the at least one constraint parameter, e.g., the suppression ratio is a ratio of frequency capped impressions to non-frequency capped impressions.

At block 410, one or more impressions in the first quantity of impressions per user is suppressed to generate a second quantity of impressions per user. The impressions may be suppressed by applying a Poisson process in which the suppression ratio is determined by a Poisson distribution mean for the at least one constraint parameter. A first standard Poisson parameter for a distribution of impressions per user for the at least one constraint parameter and a second standard Poisson parameter for the distribution of impressions per user for the at least one constraint parameter may be estimated by one or more processes. The second standard Poisson parameter may be estimated based on the first standard Poisson parameter and an estimated probability of a set of interface elements being selected for presentation based on the at least one constraint parameter. In this manner, the second quantity of impressions per user is predicted in view of the frequency cap parameters.

At block 412, a total quantity of successful impressions for a campaign represented by the constraint parameters is estimated based on the second quantity of impressions per user. The total quantity of impressions represents an expected number of non-guaranteed digital space slots that will be obtained by a usage proposal including the constraint parameters received at block 404. The total number of impressions may be compared against one or more required metrics, such as one more or required quantity of impressions, one or more resource allocation or usage rates, etc., and, at block 414, one or more of the constraint parameters may be adjusted based on the analysis of the total quantity of impressions. At block 416, the method 400 ends.

FIGS. 5A-5B depict a flowchart of an example method 500 for estimating selected impressions without frequency capping constraints and with frequency capping constraints, in accordance with some embodiments. The method 500 begins at block 502 and proceeds to block 504, where a first quantity of impressions is generated by sampling historical data. The sampling may be performed for a plurality of users for a predetermined number of days (“D”) with a targeting cut (“Q”), for example, provided as constraint parameters, which may be represented as:

$$\frac{I}{U} ( Q , D )$$

At block 506, a parameter (β) indicating a rate of increase in a size of overlap set (e.g., overlap factor) between unique users in a duration of N days and unique users on day (N+1) is determined (e.g., computed, modeled). The parameter β may be represented as:

$$β = - log ( 1 - \frac{U ( Q , 1 )}{{U}_{{Q}_{max}}} )$$

which is a non-linear function that computes the rate of increase in the size of an overlap set where U (Q, 1) is an expected daily unique user for each Q, U_{Q}_{ₘₐₓ} is an expected maximum unique user reach for Q over an unbounded time interval. In some embodiments, U_{Q}_{ₘₐₓ} may be determined from historical data from a predetermined time horizon that is significantly longer as compared to the set of days D, such as, for example ten to twelve months.

At block 508, the impressions per user (e.g., first quantity of impressions) corresponding to expected impressions can be determined (e.g., computed, estimated) for the given targeting cut Q and a campaign duration T (e.g., in days), for example, according to the equation:

$$\frac{I}{U} ( Q , T ) = \frac{I}{U} ( Q , D ) * \frac{T}{D} * \frac{1 - exp ( - β \cdot D )}{1 - exp ( - β \cdot T )}$$

where the non-linear factor is estimated using an exponentially saturating overlaps model. The first quantity of impressions per user may be represented as I/U (Q, T, b, B), e.g., the quantity of selected proposals (e.g., winning impressions) per user for a given set of constraint factors. I/U (Q, T, b, B) may be modeled as a Poisson process.

At block 510, a first standard Poisson distribution parameter, λₚₒᵢₛₛₒₙ (Q, T) may be determined (e.g., estimated, calculated) for a distribution of impressions per user for the targeting cut (Q) and the duration (T). At block 512, an expected selection rate (e.g., an expected selection probability), selection_rate (Q, b, B), corresponding to a probability of the targeting cut (Q) being selected for an available digital space slot based on a resource value (b) and a resource budget (B), is obtained. The selection_rate may be obtained from a data store including one or more predetermined selection rates. The data store may be accessible by an internal API.

At block 514, a second standard Poisson distribution parameter, λ_{poisson_WI} (Q, T, b, B) is determined (e.g., estimated) for a distribution of selectable impressions per user for the targeting cut (Q), the duration (T), the resource value (b), and the resource budget (B), using λₚₒᵢₛₛₒₙ (Q, T) and selection_rate (Q, b, B). For example, applying a property of a Poisson splitting process, the parameter for the split process for the selected impressions may be described as:

$${λ}_{poisson\_W 1} ( Q , T , b , B ) = {λ}_{poisson} ( Q , T ) * selection\_rate ( Q , b , B )$$

At block 516, a frequency cap-agnostic expected selected impressions per user ratio (e.g., an impression per user ratio determined without consideration of frequency cap constraints) is determined for all constraints. For example, in some embodiments, the frequency cap-agnostic expected selected impressions per user ratio may be determined according to λ_{poisson_WI} (Q, T, b, B). Additional details regarding generation of the first quantity of impressions, as well as other details of digital space allocation systems, may be found in co-owned U.S. patent Ser. No. 18/405,147, filed Jan. 5, 2024, entitled “Systems and Methods for Forecasting Unique User Counts for Advertising Campaigns,” which is incorporated by reference herein in its entirety. The method proceeds to block 518.

As illustrated in FIG. 5B, the method 500 proceeds from block 518 to block 520, where a selection_rate (Q, b, B) corresponding to a likelihood of a proposed usage defined by the targeting cut (Q), the resource value (b), and the resource budget (B) is obtained. The selection_rate (Q, b, B) obtained at block 520 is the same selection_rate (Q, b, B) obtained at block 512 and, in some embodiments, block 520 is a substitute for block 512.

At block 522, a standard Poisson parameter, λ_{d}_{ᵢ} is obtained for each frequency cap parameter in a set of frequency cap parameters and for an expected selected impression distribution for the corresponding targeting cut (Q), the duration (T), the resource value (b), and the resource budget (B). For example, a set of n constraints, where n is an integer greater than zero, may be denoted as “c” such that:

$$c = ( {c}_{1} , {d}_{1} ) , ( {c}_{2} , {d}_{2} ) , … , ( {c}_{n} , {d}_{n} )$$

where cᵢ is a capping parameter and dᵢ is a duration parameter for the capping parameter (e.g., a time period at which the corresponding capping parameter resets). A standard Poisson parameter, λ_{d}_{ᵢ} may be obtained for each frequency cap cₙ for targeting cut (Q), the resource value (b), and the resource budget (B) using a corresponding selection_rate (Q, b, B) and the λₚₒᵢₛₛₒₙ (Q, T) parameter.

At block 524, a frequency cap suppression ratio (e.g., a frequency cap constraint (“FCR”)) may be determined for each frequency cap (cᵢ, dᵢ) using the selection_rate (Q, b, B) and the corresponding standard Poisson parameter, λ_{d}_{ᵢ}, e.g.:

$${FCR}_{i} = \frac{{Selected\_Impressions}_{FC} ( Q , T , b , B , {c}_{i} , {d}_{i} )}{Selected\_Impressions ( Q , T , b , B )}$$

such that the suppression ratio (e.g., FCR constraint) for the i^{th} frequency cap constraint is:

$${FCR}_{i} = \frac{{c}_{i} + {\sum }_{k = 0}^{{c}_{i}} [ ( k - {c}_{i} ) ( exp ( {λ}_{{d}_{i}} * p ) \cdot \frac{{( {λ}_{{d}_{i}} * p )}^{k}}{k !} ) ]}{{λ}_{{d}_{i}} * p}$$

where λ_{d}_{ᵢ}=λ_{poisson_WI} (Q, dᵢ, b, B) and p=selection_rate (Q, b, B).

At block 526, a suppression rate (FCR) for the most restrictive frequency cap is determined, for example, using a min function, e.g.:

$${FCR}_{eff} = {min}_{i} {FCR}_{i}$$

where FCR_{eff} is the impact of the frequency cap parameter.

At block 528, the final expected selected impressions is determined for a set of constraints (e.g., Q, T, b, B, c) by suppressing the frequency cap-agnostic expected selected impressions by the most restrictive frequency cap restraint, FCR_{eff}. The suppression ratio may be applied by removing a percentage of the impressions in the first quantity of impressions equal to the suppression ratio. The removed impressions may include impressions removed from any portion of the first quantity of impressions. In some embodiments, the second quantity of selected impressions is generated as:

$${I}_{FC} ( Q , T , b , B , c ) = O ( Q , T , b , B ) * selection\_rate ( Q , b , B ) * {FCR}_{eff}$$

where I_{FC} is the second quantity of selected impressions and O is the opportunities for display of digital content in the selected digital space (e.g., the number of non-guaranteed slots for display of digital content for the digital space). At block 530, the method 500 ends.

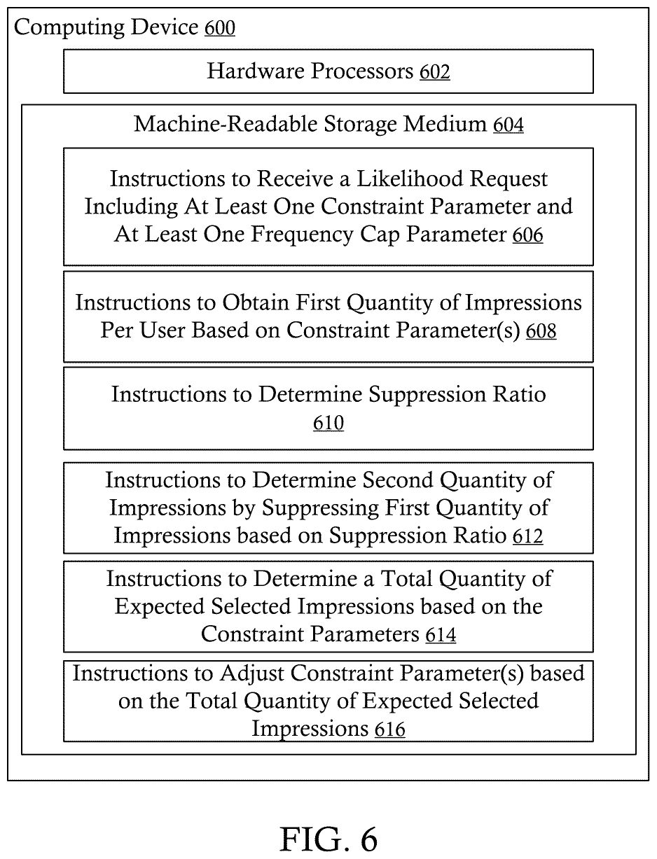

FIG. 6 depicts an example system 600 for determining a total quantity of expected selected impressions that includes a machine-readable medium 604 encoded with example instructions executable by processing resource 602. In some implementations, the system 600 may be useful for implementing aspects of the system 100 of FIG. 1 or performing the aspects of methods 400, 500 of FIGS. 4-5B. For example, the instructions encoded on machine-readable medium 604 may be included in instructions 108 of FIG. 1. In some implementations, functionality described with respect to FIG. 1 may be included in the instructions encoded on machine-readable medium 604.

The processing resource 602 may include a microcontroller, a microprocessor, central processing unit core(s), an ASIC, an FPGA, and/or other hardware device suitable for retrieval and/or execution of instructions from the machine-readable medium 604 to perform functions related to various examples. Additionally or alternatively, the processing resource 602 may include or be coupled to electronic circuitry or dedicated logic for performing some or all of the functionality of the instructions described herein.

The machine-readable medium 604 may be any medium suitable for storing executable instructions, such as RAM, ROM, EEPROM, flash memory, a hard disk drive, an optical disc, or the like. In some example implementations, the machine-readable medium 604 may be a tangible, non-transitory medium. The machine-readable medium 604 may be disposed within the system 600 in which case the executable instructions may be deemed installed or embedded on the system. Alternatively, the machine-readable medium 604 may be a portable (e.g., external) storage medium, and may be part of an installation package.

As described further herein below, the machine-readable medium 604 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIG. 6.

The machine-readable medium 604 includes instructions 606-616. Instructions 606, when executed, cause the processing resource 602 to receive a likelihood request including at least one constraint parameter and at least one frequency cap parameter. The one or more constraint parameters may include parameters for selection of a digital space proposal, such as targeting cuts, duration, allocated resources, etc. The one or more frequency cap parameters may include frequency constraints for a campaign represented by the constraint parameters, such as a first frequency cap constraint of X impressions per unique user for a first time period and a second frequency cap constraint of Y impressions per unique user for a second time period, where the first and second time periods may be different.

Instructions 608, when executed, cause the processing resource 602 to obtain a first quantity of impressions per user agnostic to the frequency cap constraints are obtained. The first quantity of impressions per user may be obtained using any suitable process, such as an ESO process that estimates impressions per user based on past campaigns that have similar (e.g., overlapping) constraint parameters. As discussed above, the first quantity of impressions per user is obtained without consideration of the impact of frequency cap parameters.

Instructions 610, when executed, cause the processing resource 602 to determine a frequency cap suppression ratio. The frequency cap suppression ratio may be generated for the most restrictive of the frequency cap parameter received. The suppression ratio is a ratio of a likelihood the digital content is selected for display under the at least one constraint parameter and the frequency cap constraint to a likelihood the digital content is selected for display under the at least one constraint parameter, e.g., the suppression ratio is a ratio of frequency capped impressions to non-frequency capped impressions.

Instructions 612, when executed, cause the processing resource 602 to determine a second quantity of impressions by suppressing one or more impressions in the first quantity of impressions based on the suppression ratio. The impressions may be suppressed by applying a Poisson process in which the suppression ratio is determined by a Poisson distribution mean for the at least one constraint parameter.

Instructions 614, when executed, cause the processing resource 602 to determine a total quantity of successful impressions for a campaign represented by the constraint parameters based on the second quantity of impressions per user. The total quantity of impressions represents an expected number of non-guaranteed digital space slots that will be obtained by a usage proposal including the constraint parameters. Instructions 616, when executed, cause the processing resource 602 to adjust one or more of the constraint parameters based on the total quantity of expected selected impressions.

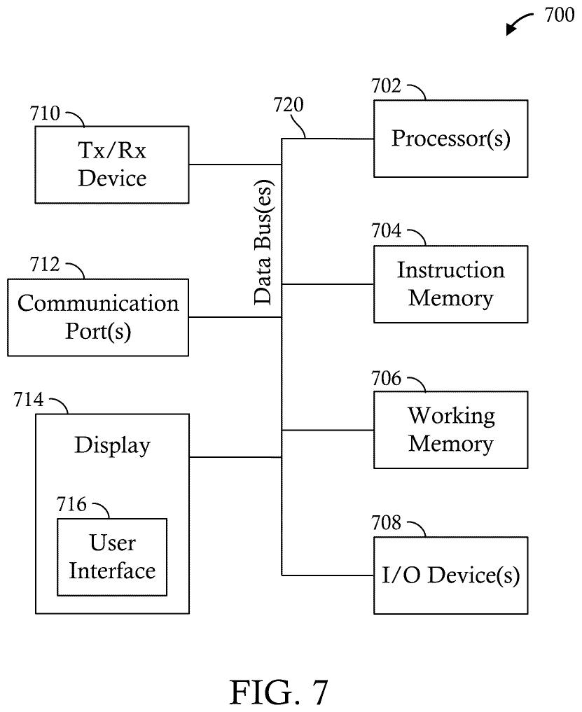

FIG. 7 illustrates a block diagram of a computing device 700, in accordance with some embodiments. Although FIG. 7 is described with respect to certain components shown therein, it will be appreciated that the elements of the computing device 700 may be combined, omitted, and/or replicated. In addition, it will be appreciated that additional elements other than those illustrated in FIG. 7 may be added to the computing device.

As shown in FIG. 7, the computing device 700 may include one or more processing resources 702, instruction memory 704, working memory 706, input/output devices 708, transceiver 710, communication port(s) 712, display 714, and/or any other suitable elements each operatively coupled to one or more data buses 720. The data buses 720 allow for communication among the various components. The data buses 720 may include wired, or wireless, communication channels.

The one or more processing resources 702 may include any processing circuitry operable to control operations of the computing device 700. In some embodiments, the one or more processing resources 702 include one or more distinct processors, each having one or more cores (e.g., processing circuits). Each of the distinct processors may have the same or different structure. The one or more processing resources 702 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processing resources 702 may also be implemented by a controller, a microcontroller, an application specific integrated circuit (ASIC), a field programmable gate array (FPGA), a programmable logic device (PLD), etc.

In some embodiments, the one or more processing resources 702 implement an operating system (OS) and/or various applications. Examples of an OS include, operating systems generally known under various trade names such as Apple macOS™, Microsoft Windows™, Android™, Linux™, and/or any other proprietary or open-source OS. Examples of applications include, network applications, local applications, data input/output applications, and user interaction applications.

The instruction memory 704 may store instructions that are accessed (e.g., read) and executed by at least one of the one or more processing resources 702. For example, the instruction memory 704 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processing resources 702 may perform a certain function or operation by executing code stored on the instruction memory 704, embodying the function or operation. For example, the one or more processing resources 702 may execute code stored in the instruction memory 704 to perform one or more of any function, method, or operation disclosed herein.

Additionally, the one or more processing resources 702 may store data to, and read data from, the working memory 706. For example, the one or more processing resources 702 may store a working set of instructions to the working memory 706, such as instructions loaded from the instruction memory 704. The one or more processing resources 702 may also use the working memory 706 to store dynamic data created during one or more operations. The working memory 706 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 704 and working memory 706, it will be appreciated that the computing device 700 may include a single memory unit that operates as both instruction memory and working memory. Further, although embodiments are discussed herein including non-volatile memory, it will be appreciated that computing device 700 may include volatile memory components in addition to at least one non-volatile memory component.

In some embodiments, the instruction memory 704 and/or the working memory 706 includes an instruction set, in the form of a file for executing various methods, such as methods for generating a total number of expected selected impressions based on one or more constraint parameters and one or more frequency cap parameters, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl. In some embodiments a compiler or interpreter converts the instruction set into machine executable code for execution by the one or more processing resources 702.

The input/output devices 708 may include any suitable device that allows for data input or output. For example, the input/output devices 708 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 710 and/or the communication port(s) 712 allow for communication with a network. For example, if a communication network is a cellular network, the transceiver 710 allows communications with the cellular network. In some embodiments, the transceiver 710 is selected based on the type of the communication network the computing device 700 will be operating in. The one or more processing resources 702 are operable to receive data from, or send data to, a network, via the transceiver 710.

The communication port(s) 712 may include any suitable hardware, software, and/or a combination of hardware and software that is capable of coupling the computing device 700 to one or more networks and/or additional devices. The communication port(s) 712 may be arranged to operate with any suitable technique for controlling information signals using a desired set of communications protocols, services, or operating procedures. The communication port(s) 712 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 712 allows for the programming of executable instructions in the instruction memory 704. In some embodiments, the communication port(s) 712 allow for the transfer (e.g., uploading or downloading) of data, such as machine learning model training data.

In some embodiments, the communication port(s) 712 couples the computing device 700 to a network. The network may include local area networks (LAN) as well as wide area networks (WAN) including without limitation the Internet, wired channels, wireless channels, communication devices including telephones, computers, wire, radio, optical and/or other electromagnetic channels, and combinations thereof, including other devices and/or components capable of or associated with communicating data. For example, the communication environments may include in-body communications, various devices, and various modes of communications such as wireless communications, wired communications, and combinations of the same.

In some embodiments, the transceiver 710 and/or the communication port(s) 712 utilize one or more communication protocols. Examples of wired protocols may include, but are not limited to, Universal Serial Bus (USB) communication, RS-232, RS-422, RS-423, RS-485 serial protocols, Fire Wire, Ethernet, Fibre Channel, MIDI, ATA, Serial ATA, PCI Express, T-1 (and variants), Industry Standard Architecture (ISA) parallel communication, Small Computer System Interface (SCSI) communication, and Peripheral Component Interconnect (PCI) communication. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), and ZigBcc.

The display 714 may be any suitable display, and may display the user interface 716. The user interfaces 716 may enable user interaction with the computing device 700. The display 714 may include a screen such as, for example, a Liquid Crystal Display (LCD) screen, a light-emitting diode (LED) screen, an organic LED (OLED) screen, a movable display, or a projection. In some embodiments, the display 714 may include a coder/decoder, also known as Codecs, to convert digital media data into analog signals. For example, the visual peripheral output device may include video Codecs, audio Codecs, or any other suitable type of Codec.

In some embodiments, the computing device 700 implements one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality that (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices) that execute an operating system, system programs, and application programs, while also implementing the engine using multitasking, multithreading, distributed (e.g., cluster, peer-peer, cloud) processing where appropriate, or other such techniques. Accordingly, each module/engine may be realized in a variety of physically realizable configurations, and should generally not be limited to any particular example implementation herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than are specifically illustrated in the embodiments herein.

In some embodiments, the computing device 700 may be a computer, a workstation, a laptop, a server such as a cloud-based server, or any other suitable device. In some embodiments, the computing device 700 is a server that includes one or more processing units, such as one or more graphical processing units (GPUs), one or more central processing units (CPUs), and/or one or more processing cores. The computing device 700 may, in some embodiments, execute one or more virtual machines. In some embodiments, processing resources (e.g., capabilities) of the computing device 700 are offered as a cloud-based service (e.g., cloud computing).

In some embodiments, the disclosed systems and methods may be used for digital space determinations in the form of digital advertising determinations for managing inventory of non-guaranteed (e.g., auctioned) digital space. Digital advertising campaigns may be targeted at non-guaranteed digital spaces included on participating websites or other digital spaces. A digital space determination may be implemented to determine an expected quantity of selected advertising impressions (e.g., winning impressions) based on proposed factors for the corresponding auction and frequency cap parameters of the non-guaranteed space. The disclosed systems and methods enable high quality determinations for expected digital space usage to be generated to allow advertisers to manage their allocation of resources to an inventory of advertisements for an available inventor of digital space.

Although embodiments are illustrated herein including certain systems and/or devices, it will be appreciated that additional systems, servers, storage mechanism, etc. may be included. In addition, although embodiments are illustrated herein having individual, discrete systems, it will be appreciated that, in some embodiments, one or more systems may be combined into a single logical and/or physical system. Similarly, although embodiments are illustrated having a single instance of each device or system, it will be appreciated that additional instances of a device may be implemented. In some embodiments, two or more systems may be operated on shared hardware in which each system operates as a separate, discrete system utilizing the shared hardware, for example, according to one or more virtualization schemes.

Although the subject matter has been described in terms of example embodiments, it is not limited thereto. Rather, the appended claims should be construed broadly, to include other variants and embodiments that may be made by those skilled in the art.

What is claimed is:

1. A system, comprising:
a processor; and
a non-transitory memory storing instructions that, when executed, cause the processor to:
receive a likelihood request for display of digital content in a non-guaranteed digital space, wherein the likelihood request includes at least one constraint parameter and at least one frequency cap parameter;
obtain a first quantity of impressions per user based on the at least one constraint parameter;
determine a suppression ratio for the at least one frequency cap parameter, wherein the suppression ratio is a ratio of a selection likelihood under the at least one constraint parameter and the frequency cap parameter to a selection likelihood under the at least one constraint parameter;
suppress one or more of the first quantity of impressions per user based on the suppression ratio to generate a second quantity of impressions per user; and
adjust the at least one constraint parameter based on the second quantity of impressions per user.

2. The system of claim 1, wherein the second quantity of impressions per user is generated based on a Poisson process, and wherein the suppression ratio is determined by a Poisson distribution mean for the at least one constraint parameter.

3. The system of claim 2, wherein the instructions, when executed, cause the processor to estimate a first standard Poisson parameter for a distribution of impressions per user for the at least one constraint parameter.

4. The system of claim 3, wherein the instructions, when executed, cause the processor to estimate a second standard Poisson parameter for the distribution of impressions per user for the at least one constraint parameter, wherein the second standard Poisson parameter is estimated based on the first standard Poisson parameter.

5. The system of claim 1, wherein the at least one frequency cap parameter includes two or more frequency cap parameters, and wherein the instructions, when executed, cause the processor to:
determine a respective frequency cap suppression ratio for each of the two or more frequency cap parameters;
determine a most restrictive frequency cap suppression ratio from the respective frequence cap suppression ratios; and
generate the second quantity of impressions per user based on the most restrictive frequency cap suppression ratio.

6. The system of claim 1, wherein the first quantity of expected selected impressions per user is obtained by:
determining a rate of size increase of an overlap user set between users in a first duration and users in a second duration; and
determining a quantity of users that satisfy the at least one constraint based on an overlap factor and historical sampled data for a respective duration.

7. The system of claim 1, wherein the at least one constraint parameter includes at least one of a targeting cut, a duration, a resource value, or a resource budget.

8. A computer-implemented method, comprising:
receiving a likelihood request for display of digital content in a non-guaranteed digital space, wherein the likelihood request includes at least one constraint parameter and at least one frequency cap parameters;
obtaining a first quantity of impressions per user based on the at least one constraint parameter;
determining a suppression ratio for the at least one frequency cap parameters, wherein the suppression ratio is a ratio of a selection likelihood under the at least one constraint parameter and the frequency cap parameters to a selection likelihood under the at least one constraint parameter;
suppressing one or more of the first quantity of impressions per user based on the suppression ratio to generate a second quantity of impressions per user; and
adjusting the at least one constraint parameter based on the second quantity of impressions per user.

9. The computer-implemented method of claim 8, wherein the second quantity of impressions is generated based on a Poisson process, and wherein the suppression ratio is determined by a Poisson distribution mean for the at least one constraint parameter.

10. The computer-implemented method of claim 9, comprising estimating a first standard Poisson parameter for a distribution of impressions per user for the at least one constraint parameter.

11. The computer-implemented method of claim 10, comprising estimating a second standard Poisson parameter for the distribution of impressions per user for the at least one constraint parameter, wherein the second standard Poisson parameter is estimated based on the first standard Poisson parameter and the first quantity of impressions per user.

12. The computer-implemented method of claim 8, wherein the at least one frequency cap parameter includes two or more frequency cap parameters, the computer-implemented method comprising:
determining a respective frequency cap suppression ratio for each of the two or more frequency cap parameters;
determining a most restrictive frequency cap suppression ratio from the respective frequence cap suppression ratios; and
generating the second quantity of expected selected impressions per user based on the most restrictive frequency cap suppression ratio.

13. The computer-implemented method of claim 8, wherein the first quantity of impressions per user is obtained by:
determining a rate of size increase of an overlap user set between users in a first duration and users in a second duration; and
determining a quantity of users that satisfy the at least one constraint based on an overlap factor and historical sampled data for a respective duration.

14. The computer-implemented method of claim 8, wherein the at least one constraint parameter includes at least one of a targeting cut, a duration, a resource value, or a resource budget.

15. A non-transitory computer-readable medium having instructions stored thereon, wherein the instructions, when executed by at least one processor, cause at least one device to perform operations comprising:
receiving a likelihood request for display of digital content in a non-guaranteed digital space, wherein the likelihood request includes at least one constraint parameter and at least one frequency cap parameter;
obtaining a first quantity of expected selected impressions per user based on the at least one constraint parameter;
determining a suppression ratio for the at least one frequency cap parameter, wherein the suppression ratio is a ratio of a selection likelihood under the at least one constraint parameter and the frequency cap parameter to a selection likelihood under the at least one constraint parameter;
suppressing one or more of the first quantity of expected selected impressions per user based on the suppression ratio to generate a second quantity of expected selected impressions per user; and
adjusting the at least one constraint parameter based on the second quantity of impressions per user.

16. The non-transitory computer-readable medium of claim 15, wherein the second quantity of expected selected impressions per user is generated based on a Poisson process, and wherein the suppression ratio is determined by a Poisson distribution mean for the at least one constraint parameter.

17. The non-transitory computer-readable medium of claim 16, wherein the instructions cause the at least one device to perform operations comprising estimating a first standard Poisson parameter for a distribution of impressions per user for the at least one constraint parameter.

18. The non-transitory computer-readable medium of claim 17, wherein the instructions cause the at least one device to perform operations comprising estimating a second standard Poisson parameter for the distribution of impressions per user for the at least one constraint parameter, wherein the second standard Poisson parameter is estimated based on the first standard Poisson parameter and the first quantity of impressions per user.

19. The non-transitory computer-readable medium of claim 15, wherein the at least one frequency cap parameter includes two or more frequency cap parameters, and wherein the instructions cause the at least one device to perform operations comprising:
determining a respective frequency cap suppression ratio for each of the two or more frequency cap parameters;
determining a most restrictive frequency cap suppression ratio from the respective frequence cap suppression ratios; and
generating the second quantity of expected selected impressions per user based on the most restrictive frequency cap suppression ratio.

20. The non-transitory computer-readable medium of claim 15, wherein the first quantity of impressions per user is obtained by:
determining a rate of size increase of an overlap user set between users in a first duration and users in a second duration; and
determining a quantity of users that satisfy the at least one constraint based on an overlap factor and historical sampled data for a respective duration.
